(19) United States
(12) Patent Application Publication
(10) Pub. No.: US 2016/0250661 A1
(43) Pub. Date: Sep. 1, 2016

(54) UV-CURING PROCESS WITH EXTERIOR MASKING FOR INTERNAL AND SELECTIVE DECORATION OF TUBE-LIKE AND 3D ELECTRONIC HOUSING

(71) Applicant: CORNING INCORPORATED, CORNING, NY (US)

(72) Inventors: Jeffrey Allen Miller, Elmira, NY (US); John Charles Speeckaert, Painted Post, NY (US); Haregewine Tadesse Woldegiworgis, Horseheads, NY (US)

(21) Appl. No.: 15/052,928

(22) Filed: Feb. 25, 2016

Related U.S. Application Data
(60) Provisional application No. 62/121,555, filed on Feb. 27, 2015.

(51) Int. Cl. B05D 7/22; B05D 3/06

(52) U.S. Cl. CPC B05D 7/22; B05D 3/067

(57) ABSTRACT

An aspect of the present disclosure provides a method of selectively coating an internal surface of a tube-like wall. The tube-like wall may have an internal surface, an external surface, and a hollow interior defined by the internal surface. The method may comprise steps of coating at least a portion of the internal surface of the tube-like wall with a coating material that is selectively curable by exposure to initiation energy; and selectively transmitting initiation energy from outside the tube-like wall, through the tube-like wall, into contact with a portion of the coating material, under conditions effective to cure the contacted portion of the coating material, and at least substantially without curing another portion of the coating material unexposed or less-exposed to the initiation energy.

This application claims the benefit of priority under 35 U.S.C. §119 of U.S. Provisional Application Ser. No. 62/121,555 filed on Feb. 27, 2015 the content of which is relied upon and incorporated herein by reference in its entirety.

### BACKGROUND

The disclosure relates to systems and methods for decorating electronics, and more particularly to systems, such as a customized and selective decoration of internal tube-like surfaces of three-dimensional electronic housing, and methods of ultraviolet-curing process with exterior masking or an ultraviolet laser for internal and selective decoration of tube-like and three-dimensional electronic housing. The glass cover optionally may be a sleeve.

### SUMMARY

The present disclosure relates, in various embodiments, to a method for coating and decorating an internal surface of a hollow structure. The hollow structure may have a tube-like wall. The tube-like wall may have an internal surface, an external surface, and a hollow interior defined by the internal surface. The method may be useful in manufacturing a sleeve for electronics. The method may be carried out by coating at least a portion of the internal surface of the tube-like wall with a coating material that is selectively curable by exposure to initiation energy. Initiation energy may be transmitted from outside the tube-like wall through the tube-like wall and then in contact with a portion of the coating material to expose the contacted portion, forming an exposed portion, under conditions effective to cure the exposed portion of the coating material. As used in this disclosure, the term “cure” means to sufficiently harden or adhere a portion of a coating to fix it to the substrate so it is not removed by the conditions employed to remove uncured or less cured portions of the coating. Thus, a partial cure, in the sense of a curing reaction that has not proceeded to completion, is included within the definition of “curing.”

Optionally, a mask may be positioned upon an external surface of the tube-like wall before transmitting initiation energy, to provide a masked portion and an unmasked portion of the coating material, so the exposed portion of the coating material will be some or all of the unmasked portion of the coating material.

The present disclosure also relates, in various embodiments, to methods of selectively decorating a tube-like wall of a hollow structure, for example a tube-like structure such as a sleeve. The method is carried out by coating at least a portion of the internal surface of the tube-like wall with a coating material. Initiation energy may be transmitted from a source located outside the tube-like wall, through the tube-like wall, to an unmasked portion of the coating material, under conditions effective to selectively cure an unmasked portion of coating material and form a clear window on the internal surface of the tube-like wall.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a perspective view of a glass sleeve according to an embodiment.

FIG. 2 is a flow diagram illustrating an embodiment of a method for selectively coating an internal surface of a tube-like wall.

FIG. 3 is a schematic view of an embodiment of a method for selectively coating an internal surface of a tube-like wall.

FIG. 4 is a schematic view of another embodiment of a method for selectively coating an internal surface of a tube-like wall.

FIG. 5 is a schematic view of selectively coating a corner or a curved structure according to another embodiment of the method shown in FIG. 4.

FIG. 6 is a schematic view of selectively coating a substrate via laser from two directions to create decoration features according to yet another embodiment.

The following reference characters are used in this description and the accompanying drawing figures.

| | |
|---|---|
| 100 | hollow tabular structure/glass sleeve |
| 110 | One edge of glass sleeve 100 |
| 120 | Another edge of glass sleeve 100 |
| 130 | First flat face |
| 140 | Second opposed generally flat face |
| 160 | Tube-like wall of glass sleeve 100 |
| 162 | Internal surface |
| 164 | External surface |
| 166 | Hollow interior |
| 170 | length of a glass sleeve |
| 180 | Internal opening |
| 190 | Glass thickness |
| 200 | A method of selectively coating an internal surface of a tube-like |
| | wall. |
| 210 | First step of the method 200. |
| 220 | Second step of the method 200. |
| 310 | ultraviolet light source |
| 320 | collimated lens |
| 330 | Mask |
| 340 | ultraviolet curable ink |
| 410 | Ultraviolet laser |
| 420 | Laser beam |
| 430 | A clear window |
| 450 | An exposed portion of the coating material |
| 610 | Substrate |

### DETAILED DESCRIPTION

The present disclosure can be understood more readily by reference to the following detailed description, drawings, examples, and claims, and their previous and following description. However, before the present compositions, articles, devices, and methods are disclosed and described, it is to be understood that this disclosure is not limited to the specific compositions, articles, devices, and methods disclosed unless otherwise specified, as such can, of course, vary. It is also to be understood that the terminology used herein is for the purpose of describing particular aspects only and is not intended to be limiting.

The following description of the disclosure is provided as an enabling teaching of the disclosure in its currently known embodiments. To this end, those skilled in the relevant art will recognize and appreciate that many changes can be made to the various aspects of the disclosure described herein, while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

Disclosed are materials, compounds, compositions, and components that can be used for, can be used in conjunction with, can be used in preparation for, or are embodiments of the disclosed method and compositions. These and other materials are disclosed herein, and it is understood that, when combinations, subsets, interactions, groups, etc. of these materials are disclosed, while specific reference of each various individual and collective combinations and permutation of these compounds may not be explicitly disclosed, each is specifically contemplated and described herein.

Reference will now be made in detail to the present preferred embodiment(s), examples of which are illustrated in the accompanying drawings. The use of a particular reference character in the respective views indicates the same or like parts.

As noted above, broadly, this disclosure teaches a process to decorate internal tubular surfaces of a three-dimensional electronic housing. The method is applicable to any shaped glass, and is particularly useful for three-dimensional shaped parts, for example, for tubes and sleeves. Tube-like structures made out of glass, transparent ceramic, and transparent plastic materials may be applicable as next generation electronic housings.

“Hollow-like” and “tube-like” structures are synonymous in the present disclosure, and each is defined for purposes of the present disclosure as including a conventionally understood hollow or tubular structure, which for example may have a cylindrical wall with a round, oval, flattened, rectangular, or other cross-section completely surrounding an internal space, and also including a wall with a cross section, for example a C-shaped cross section, partially but not fully surrounding the corresponding cross-section of the hollow or interior space. “Hollow-like” and “tube-like” structure also include a structure in which a wall cross-section encircles a hollow interior cross-section along a portion of the length of the structure, but a wall cross-section does not encircle the corresponding hollow interior cross-section along another portion of the length of the structure. A structure that changes in cross-sectional size or shape along its length and a structure that is tube-like along a portion of its length and not tube-like along another portion of its length also is included within the definition of “hollow-like” and “tube-like” structure.

This disclosure may present a novel selective decoration strategy by using ultraviolet-curable ink or other materials, which may be well known or commercially available materials, and processes that may be applied to decorate tube-like transparent substrates for electronic enclosure applications. The aforementioned approach may utilize exterior masking to enable the display area of the sleeve to remain clear and uncoated, while the rest of the internal structure is selectively decorated. In another embodiment, an additional way or the second method of decorating the tube-like structure could be, by exposing the ultraviolet-curable ink selectively with an ultraviolet-laser in such a way that the laser may cure the ultraviolet ink only in the areas that are to remain selectively clear and uncoated. The second embodiment can be carried out with or without a mask.

The methods provide the following advantages: the embodiments may enable selective decoration of the internal structure of tube-like structure with isolated uncoated window or other areas. The approach may use exterior masking with ultraviolet decorating materials applied inside, and directionally controlled ultraviolet radiation exposure (two examples of “directionally controlled” radiation are collimated radiation and laser radiation) for curing with clear demarcation and smoother edges.

Another embodiment of the method may be rapid, and simple, as masking the outside of the tube-like structure is faster and easier than masking the inside of the tube-like structure, especially when the internal dimension of the tube-like structure is very narrow. Masking and demasking in a confined space may not be needed. It may be easier and more accurate to properly align the mask from outside, as the exterior masking approach which may offer more control on positioning the mask.

The embodiment that provides a rapid process of decoration using an ultraviolet-curable material and exterior masking may reduce the coating, internal masking and internal demasking time for the process significantly. This may also reduce the mechanical complexity of applying internal masking and demasking.

The decoration approach may provide potentially precise thickness and optical density control. Common edge imprecision problems, such as typical ink bumps at the borders and edges that are common in screen and other types of printing, may be eliminated. The smoother transition from the tube-like structure surface to the decorated region may make the application of anti-splinter or other strength enhancing materials easier.

The embodiment of the process may potentially enable applying precise and selective decoration of tube-like structures with different internal geometries, and three-dimensional shapes for electronic housing application. The electronic enclosure tubes optionally may be made in part or whole out of strong glasses, tough transparent ceramics, plastics or a combination of such materials. Optically clear adhesives that are applied inside the internal structure of the tube and electronic components may be bonded with the tube-like structure. Decorating patterns may be customized with variety of color selections. One color or mix of multiple colors may offer wider decoration choices.

A high level optical quality may be produced to ensure the aesthetic characteristics contemplated for such an object as well as the display functionality, for example, freedom from noticeable optical defects such as lack of clarity or presence of debris. Other preferred characteristics of the sleeves are a high level of mechanical performance (to prevent breakage) and scratch resistance. To meet these criteria, for example, a Gorilla® glass composition may be particularly well suited. (Gorilla® is a trademark of Corning Incorporated, Corning, N.Y., USA, for glass, for example cover glass or a glass touch screen display in an electronic device such as a smart phone or tablet.) Optionally in any embodiment, the process may allow production of a large number of parts at high throughput and a reasonably low cost.

As used herein, the term “sleeve” describes a three-dimensional, tube-like structure or wall having a non-circular cross section and an aspect ratio greater than 1. The aspect ratio is the ratio of the largest and smallest diameters of the cross section of the tube-like structure or wall. The aspect ratio has a minimum value of 1 by definition for a round or axisymmetric tube. The aspect ratio has a value larger than 1 for a flattened sleeve. Optionally in any embodiment, aspect ratios from about 1.5 to about 50, optionally from about 3 to about 39, optionally from about 5 to about 25, optionally from about 5 to about 15, optionally from about 7 to about 11, optionally from about 18 to about 28, are contemplated.

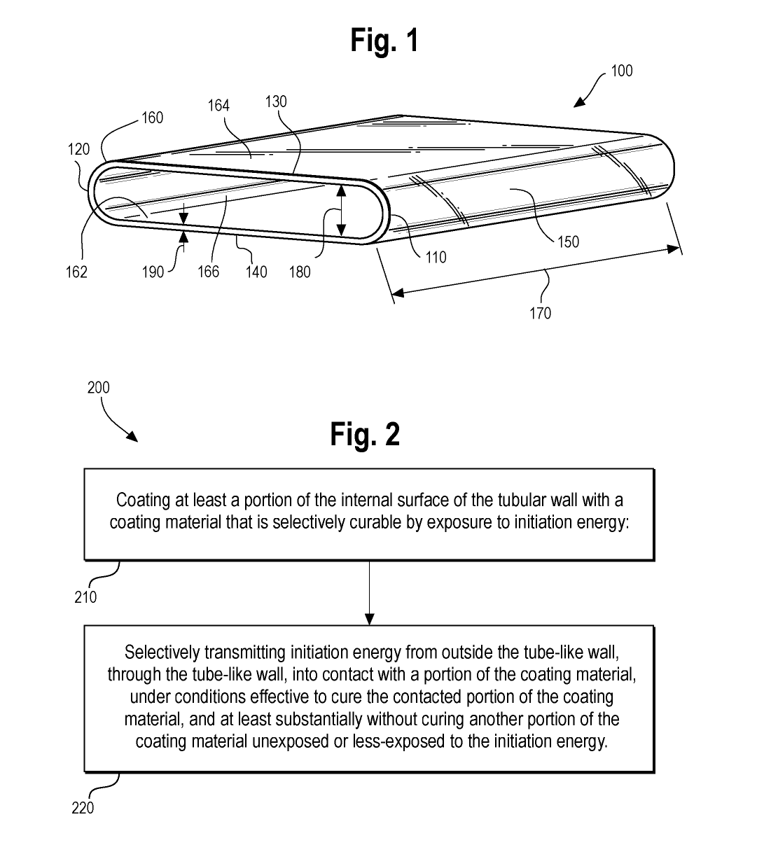

Generally, as illustrated in FIG. 1, a glass sleeve 100 may be somewhat oval in shape, wherein the edges 110 and 120 are rounded. In another embodiment, the edges may be somewhat rectangular in shape or other shapes. Optionally in any embodiment, the glass sleeve 100 may have at least one face. Optionally the glass sleeve 100 may have two opposed generally flat faces 130 and 140 that are near optically flat or optically flat. Optionally, a glass sleeve 100 or hollow tabular structure may comprise a tube-like wall 160, a length 170, an internal opening 180, and a glass thickness 190. The tube-like wall 160 may have an internal surface 162, an external surface 164, and a hollow interior 166 defined by the internal surface 162. Optionally, a glass sleeve 100 can have at least one flattened portion 130 or 140 that is, or approaches being, optically flat.

As used herein, the term “near optically flat or optically flat” describes an optical-grade piece of glass lapped and polished to be extremely flat on one or both sides, usually within a few millionths of an inch (about 25 nanometers).

While most of the embodiments herein are used particularly in application to sleeve glass enclosures, it is contemplated that the same method could be applied more widely, for example with an additional step of cutting the tubes in half or severing optically flat portions to provide for a 3D shaped cover glass, touch screen, or other part.

As shown in FIG. 2, a method 200 may be used for selectively coating an internal surface of a tube-like wall. The tube-like wall may have an internal surface, an external surface, and a hollow interior defined by the internal surface. The method is carried out by coating at least a portion of the internal surface of the tube-like wall, which may comprise a closed and seamless tube, with a coating material that is selectively curable by exposure to initiation energy in a step 210. A mask may be optionally positioned upon an external surface of the tube-like wall to provide a masked portion and an unmasked portion covering at least a portion of the coating material. Initiation energy, such as ultraviolet light, may be transmitted from outside the tube-like wall through the unmasked portion of the tube-like wall and then in contact with the coating material, and at least substantially without curing another portion of the coating material unexposed or less exposed to the initiation energy in a step 220.

The hollow tube-like structure may be a glass tube. The tube may be a circular or non-circular tube-like structure. The hollow tube-like structure may have a first aspect ratio, which may be defined as a ratio between the first diameter over the second diameter at a cross-section. Optionally in any embodiment, the aspect ratio can vary along the length of the part.

The process may start by providing a tube-like structure, such as a glass tube of the contemplated glass composition made using a traditional tubing process. Tube-like structures made out of strong glass, transparent ceramics, and tough plastics may cover electronic devices and provide competitive advantage to an existing electronic housing that is available in the market. Hence, for coating of a complex-tube-like structure with three-dimensional shapes to cover electronic components, developing mechanism of decorating these types of devices is becoming important. In most applications, coatings may be applied only to certain areas of external surfaces. The difficulties may come in when decoration is necessary to an isolated internal tube-like structure, while leaving a clearer displaying window undecorated. Moreover, the challenge becomes complicated when the dimension of the inner tube-like structure to be decorated is not great enough to easily place on and remove a mask from the interior surface of the object. The mask may be used to protect certain areas from being coated with colorant or ink.

Coating plays a vital role for a wide range of applications including, electronics, automotive, aerospace, and several other industries. The coating may impart desired characteristics to parts, such as providing or improving surface properties, appearance, scratch resistance, wear resistance, adhesion, wettability, or corrosion resistance, anti-reflective, anti-glare, or anti-microbial properties, for covering specific parts to be coated or for decoration purposes. Coating of parts may involve liquid coating, such as dip coating, spin coating, spray coating, thin film coating, plating, powder coating, or electroplating, gravitational sedimentation, self-assembly under confinement, assembly at an air-liquid interface, etc.

Having a narrow dimension for a standard coating may result in a non-uniform and uncontrolled coating. This may make it difficult to precisely place the decoration on the tube-like structure and limit the manufacturability of the process. The use of a selective decoration strategy using ultraviolet-curable decoration materials and processes is contemplated, for example. An embodiment using an exterior masking approach is contemplated to enable some portions of the tube-like structure to remain uncoated while other portions of the internal structure are selectively coated.

In the step 210, the coating material used may include an ultraviolet curable ink in one embodiment. In another embodiment, the coating material may include a decorating material. In further another embodiment, the coating material may further include a plurality of conductive or semi-conductive layers. The conductive or semi-conductive layers may include a transparent conductive oxide, a conductive polymer, an organic light-emitting diode, or a combination of any two or more of these, for example. The organic light-emitting diode (OLED) may be polyanilines, polyacetylene, polypyrrole and the like. Most used organic light-emitting diode materials may include Poly(3,4-ethylenedioxythiophene) (PEDOT), Poly(3,4-ethylenedioxythiophene) (PEDOT): poly(styrene sulfonate) (PSS), Poly(4,4-dioctylcyclopentadithiophene), for example.

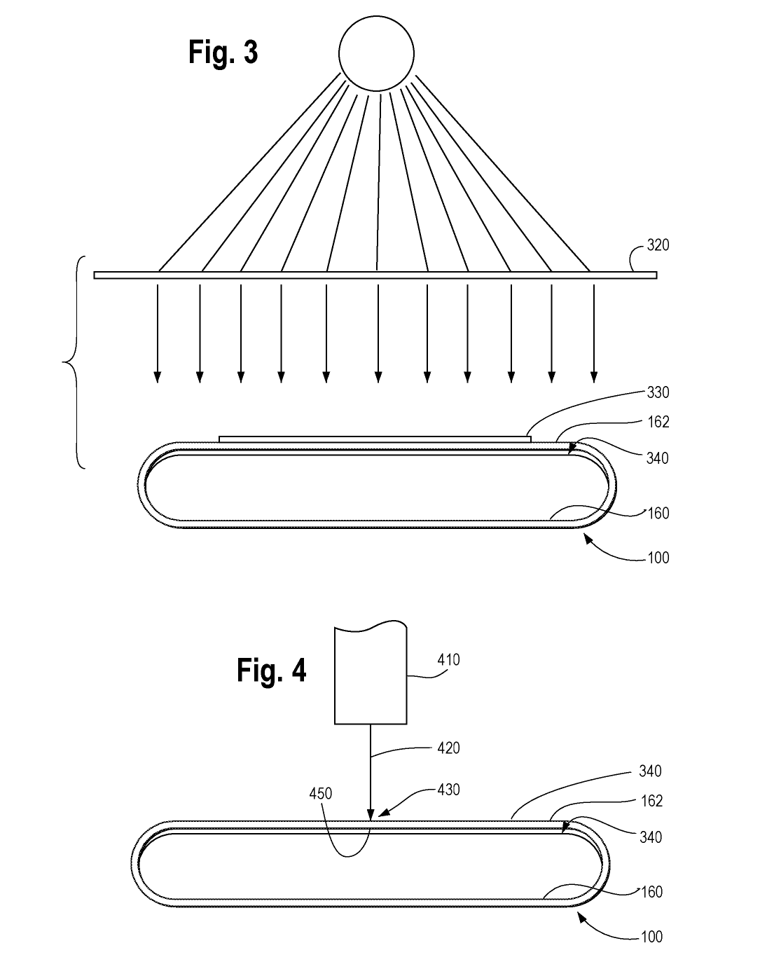

Optionally in any embodiment, the transmitting step may be carried out under conditions effective to cure an unmasked portion of the coating material more than the masked portion of the coating material. Optionally in any embodiment, the initiation energy may be transmitted in at least substantially parallel rays, as shown in FIG. 3. A collimated lens 320 may be used to filter ultraviolet light from an ultraviolet light source 310. In one embodiment, the ultraviolet curable ink 340 may be applied to at least a portion, such as one side of the internal surface 162 of the tube-like wall 160 of the glass sleeve 100. In another embodiment, the ultraviolet curable ink 340 may be applied to all parts of internal surface 162 of the tube-like wall 160.

The ultraviolet curable ink may be applied to the inside tube-like structure with spray, spin, drain, dip coatings, roller or other printing, or application via injecting or dispensing, for example. For process control and clearer border demarcation, decoration may be performed under yellow-safe light, which is light that illuminates the task sufficiently for a worker, without materially advancing or initiating curing of the coating. The exterior mask 330 may be made of ultraviolet blocking or filtering materials. The mask 330 may prevent curing the ultraviolet sensitive materials placed inside the tube-like structure and under the mask 330.

Tight placement of the mask 330 to the exterior surface of the glass sleeve 100 is contemplated to provide the best edge demarcation. The mask 330 may remain intact when the glass sleeve 100 is exposed to the ultraviolet light source 310. This may be done by securing masking of the ultraviolet blocking or filtering mask by using shrink wrap, for example. The ultraviolet mask materials may be tapes, films, metals, coated polymers or coated glass. For clear demarcation of window borders with smooth edges, a directionally controlled ultraviolet exposure as shown in FIG. 3 may be needed. In one embodiment, the ultraviolet source 310 may be collimated by a collimating lens, grid, or other known collimating structure 320 directly in a controlled fashion to the unmasked surfaces of the glass sleeve 100 for effective curing and to eliminate propagation of the radiation through the glass surface under the mask. This may enable a controlled exposure of the decorating ink to the ultraviolet exposure and inhibit fuzzy borders or rough edges. In another embodiment, the ultraviolet source 310 may be used without a collimated lens 320.

The method 200 may further include removing the masked portion of the coating materials. Once the ink is cured with ultraviolet radiation, cleaning the excessive ink or decorating material is optionally contemplated. The ultraviolet unexposed ink may remain wet and uncured. The masking material may be reused for several cycles and may be made of materials that are opaque to ultraviolet exposure. The uncured ink may be easily removed through washing. Cleaning of the residual and uncured ink with solvents may result in a controlled and selective decoration of the internal surface of the glass sleeve while isolating viewing window areas clear and uncoated.

The method 200 may include applying an optically clear adhesive to at least a portion of the interior surface of the tube-like wall previously under the mask. Optically Clear Adhesives (OCA) may create optically clear bonding and may typically be used on displays, or touch screens, or on graphic overlays. OCA materials may have strong adhesion to surfaces of the substrate (glass, transparent ceramics, toughened plastics) or with other film stacks. The film stack on the substrate may include anti-splinter, anti-reflection, anti-fingerprint, anti-glare, anti-microbial properties. The clear adhesives may have good compatibility with the other types of coatings, such as indium tin oxide (ITO) coatings, with high transmission, increasing wettability, negligible outgassing properties. Optically clear adhesives are well known, and may be made from acrylic based polymers and may have thickness from about 0.25 mm to about 5 mm, for example.

The optically clear adhesive layer may be embedded to the substrate (glass, transparent ceramics, or toughened transparent plastics) and built to form a film stacking structure that may contain anti-splinter, anti-reflection, anti-fingerprint, anti-glare, anti-microbial, and touch components (ITO or other transparent conductive or semi-conductive films). The transparent conductive or semi-conductive films may be made of both inorganic and organic materials, such as ITO or fluorine doped tin oxide (FTO) or other types of doped oxides, carbon nanotubes, or graphene, for example.

Alternatively, in another embodiment, as shown in FIG. 4, a method of selectively decorating a tube-like wall 160, such as a closed and seamless tube, may comprise coating at least a portion of the internal surface 162 of the tube-like wall 160 with a coating material and transmitting initiation energy from a source, optionally directionally controlled, such as an ultraviolet laser 410, located outside the tube-like wall 160, through the tube-like wall 160, to an unmasked portion 450 of the coating material, such as ultraviolet ink 340, under conditions effective to selectively cure an unmasked portion 450 of coating material and form a clear window 430 on the internal surface 162 of the tube-like wall 160. Optionally in any embodiment, the initiation energy may be transmitted in at least substantially parallel rays, such as laser beam 420. In one embodiment, the coating material used may include an ultraviolet curable ink 340 in one embodiment. The ultraviolet ink may be a composition that is photosensitive and may be applied to the glass sleeve using dip-coating, drain-coating, spin-coating, for example. In another embodiment, the coating material may include a decorating material. In further another embodiment, the coating material may include a plurality of conductive or semi-conductive layers. In still another embodiment, the coating material may include an anti-splinter material. The anti-splinter material may be selected from a group consisting of a polycarbonate, a polyethylene terephthalate (PET), polyester, transflective, or an acrylic material. The conductive or semi-conductive layers may include a transparent conductive oxide, a conductive polymer, an organic light-emitting diode, or a combination of any two or more of these, for example. The organic light-emitting diode (OLED) may be polyanilines, polyacetylene, polypyrrole and the like. Most used organic light-emitting diode materials may include Poly(3,4-ethylenedioxythiophene) (PEDOT), Poly(3,4-ethylenedioxythiophene) (PEDOT): poly(styrene sulfonate) (PSS), Poly(4,4-dioctylcyclopentadithiophene), for example. The ink, adhesive, or other coatings may be applied at the same or opposite side of the substrate from the laser sources.

The ultraviolet laser may be used to polymerize the photoinitiators, binders, ink, adhesive or other coatings at the time of exposure. Optionally in any embodiment, the transmitting step may be carried out under conditions effective to cure an unmasked portion of the coating material more than the masked portion of the coating material. The method may further include removing the masked portion of the coating material. In the curing process, the transparent substrate, such as the glass sleeve 100, may be exposed with laser. The radiation may transmit or propagate through the transparent substrate and initiate the curing process or chemical reaction within the ink, adhesive component, or coatings. After the laser irradiation of the ink, adhesive, or other coatings, the uncured portion of the coating material or unexposed area may be washed away using an appropriate solvent to remove uncured photosensitive materials.

In one embodiment, coating material may cover internal surfaces of the substrate, e.g. tube-like wall, as shown in FIG. 4. In another embodiment, coating material may be applied to decorate open surfaces, to selectively create patterns or small features on two dimensional or flat substrates. Ink or adhesive may be placed behind the ultraviolet transmitting or ultraviolet reflective substrate and exposed to laser. The ultraviolet laser may directly irradiate the ink placed on surfaces for non-transmitting substrates. In further embodiment, ultraviolet laser curing technique may also be applied to decorate a flexible substrate, such as a web of glass, to selectively create patterns or small features. Ink or adhesive may be placed behind the ultraviolet transmitting flexible substrate and exposed to laser. The ultraviolet laser may directly irradiate the ink placed on surfaces for non-transmitting or ultraviolet reflective flexible substrates.

The embodiments of the process may provide a controlled process for mask-free selective decoration of substrates. The process may be used to create complex patterns with small features as ultraviolet laser is focused and may cure the ink in tight spaces. The embodiment may produce smaller features on substrates that cannot be generated by using conventional decoration processes. The process also may produce finer line resolution than many other decoration techniques, i.e., screen printing, pad printing, flexographic printing, etc. Irradiation of the ink or the photosensitive materials via laser may control the area or location of features or patterns to be printed. One-dimensional lines and areas of coatings can be provided by moving the rays of the laser or other source of initiation energy with respect to the substrate during the process, whether by uniformly scanning an area or irregularly “drawing” on certain areas. The rays can be moved with respect to the substrate by moving the substrate, moving the source of irradiation, or using mirrors or other arrangements (such as electrical deflection of an ion or electron beam) to deflect the rays. Discontinuous or patterned exposure can be provided by turning the source of irradiation on and off while moving the rays with respect to the substrate. Such laser drawing methods are well known for providing pattern wise exposure or illumination.

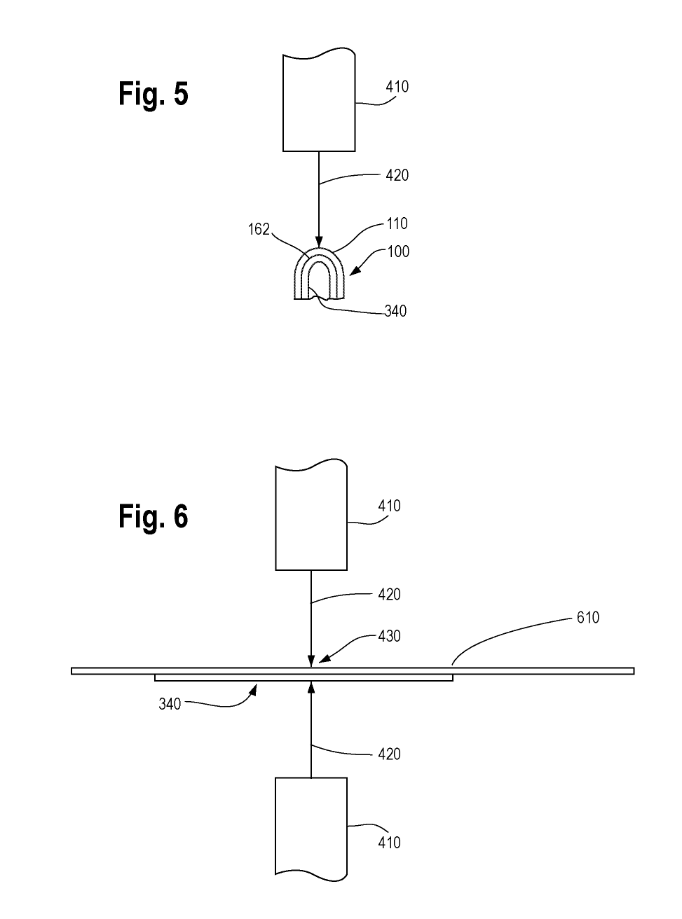

As shown in FIG. 5, the ultraviolet laser beam 420 from the ultraviolet laser source 410 may cure the coating material, such as ultraviolet curable ink 340 at the internal surface 162 of a curved or corner structure, such as one edge 110 of the glass sleeve 100. This technique may be used to selectively create labels, marks or very small features at corners, edges within confined spaces or very narrow spaces.

The embodiment may increase decoration quality, such as smooth ink edge cross-sectional profile. The decoration approach may provide potentially precise thickness and optical density control. Common edge imprecision problems, such as typical ink bumps at the borders and edges, which are common in screen and other types of printing may be eliminated. The smoother transition from the substrate surface to the decorated region may make the application of anti-splinter or other strength enhancing film easier.

Thickness and speed of curing may be dependent on laser dosage and/or coating characteristics. The coating optionally can be cured through a portion of its thickness adjacent to the substrate, as by providing a relatively opaque coating that does not transmit the irradiation to the portion of the coating opposite the substrate. The mechanism of curing may be based on transmission of laser radiation through the transparent substrate and optionally through the photosensitive material on the surface. For specific applications, different types of lasers with specific wavelengths may be selected to suit the ink or adhesive properties. Depending on the power of the laser source, curing may be achieved rapidly and may only take a few seconds, for example. In addition, the rapid process of decoration using a UV-curable material may save time and reduce mechanical complexity related to masking and demasking.

To apply thick coatings or adhesives in a prescribed pattern on the substrate, the material, such as ink, adhesive, or other coatings, may be exposed to a plurality of ultraviolet lasers 410 as shown in FIG. 6. In FIG. 6, a substrate 610, such as glass, transparent ceramic or polymer, may be exposed via laser from two directions, either both from outside the tube-like structure (respectively through opposed transparent walls of the tube-like structure) or one from outside and another from inside the tubular structure, to create features with thick cured portions of ultraviolet curable ink 340. The laser beam 420 from the ultraviolet laser 410 through the substrate 610 may enable thicker features of the ultraviolet ink 340. The ultraviolet ink 340 may include adhesive or other coatings. When the ink, adhesive or other coatings harden, curing may be achieved. Excessive ink, adhesive, or other coatings, either in unirradiated areas or in portions of the coating remote from the substrate and not hardened, or less hardened, by irradiation through the coating) may be washed away using suitable solvent. The thickness and optical density of the resulting features may be dependent on the ink types, laser residency time, power on the laser, speed of the substrate motion and dosage of the laser radiation.

The embodiment of the present disclosure may produce sharp demarcation lines and smoother edge profiles of selected patterns or small features. Numerous results have shown that the higher the ultraviolet dosage, the higher the optical density of coatings, ink or adhesives. There may also have a direct correlation between ultraviolet dosage and the resulting film thickness, and optical densities.

It will be apparent to those skilled in the art that the methods and apparatuses disclosed herein could be applied to a variety of structures having different geometries and to create selectively coated and uncoated portions of varying shapes, sizes, and orientations. It will also be apparent to those skilled in the art that various modifications and variations can be made without departing from the spirit or scope of the invention.

What is claimed is:

1. A method of selectively coating an internal surface of a tube-like wall, the tube-like wall having an internal surface, an external surface, and a hollow interior defined by the internal surface, the method comprising:
coating at least a portion of the internal surface of the tube-like wall with a coating material that is selectively curable by exposure to initiation energy; and
selectively transmitting initiation energy from outside the tube-like wall, through the tube-like wall, into contact with a portion of the coating material, under conditions effective to cure the contacted portion of the coating material, and at least substantially without curing another portion of the coating material unexposed or less-exposed to the initiation energy.

2. The method of claim 1, further comprising positioning a mask upon an external surface of the tube-like wall before the selectively transmitting step to provide a masked portion and an unmasked portion of the coating material.

3. The method of claim 1, wherein the tube-like wall comprises a closed and seamless tube.

4. The method of claim 1, wherein the initiation energy comprises ultraviolet light.

5. The method of claim 1, in which the transmitting step is carried out under conditions effective to cure an exposed portion of the coating material more than the unexposed portion of the coating material.

6. The method of claim 1, wherein the initiation energy is transmitted in at least substantially parallel rays.

7. The method of claim 1, wherein the initiation energy is transmitted by a laser.

8. The method of claim 5, in which the at least substantially parallel rays are moved in the course of the transmitting step to expose different portions of the coating material.

9. The method of claim 2, further comprising removing a masked portion of the coating material.

10. The method of claim 1, further comprising applying an optically clear adhesive to the interior surface of an unexposed portion of the tube-like wall.

11. The method of claim 7, further comprising bonding an electronic component within the internal tube-like wall, wherein the electronic component is secured to the optically clear adhesive in at least partial alignment with the window.

12. The method of claim 1, wherein the coating material comprises an ultraviolet curable ink.

13. The method of claim 1, wherein the coating material comprises a decorating material.

14. The method of claim 1, wherein the coating material comprises a plurality of conductive or semi-conductive layers, wherein the conductive or semi-conductive layers are a transparent conductive oxide, a conductive polymer, an organic light-emitting diode, or a combination of any two or more of these.

15. The method of claim 1, wherein the coating material comprises an anti-splinter material, wherein the anti-splinter material is selected from a group consisting of a polycarbonate, a polyethylene terephthalate (PET), polyester, transflective, or an acrylic materials.
